(19) United States
(12) Patent Application Publication
(10) Pub. No.: US 2014/0101983 A1
(43) Pub. Date: Apr. 17, 2014

(54) ADJUSTIBLE FISHING-REEL MOUNT AND METHODS OF USE

(71) Applicant: Bruce William Scott, Littleton, CO (US)

(72) Inventor: Bruce William Scott, Littleton, CO (US)

(21) Appl. No.: 14/125,640

(22) PCT Filed: Jul. 22, 2011
(86) PCT No.: PCT/US2011/045021

§ 371 Date: Dec. 12, 2013

(51) Int. Cl. A01K 87/06

(52) U.S. Cl. CPC A01K 87/06
USPC 43/22

(57) ABSTRACT

The disclosure is directed generally to an apparatus used to adjustably mount a fishing reel to the control end of a fishing rod. The fishing-reel-mounting apparatus is comprised of two main parts: (1) a rigid, light-weight, longitudinal track that is adapted to be securely and coupled to the standard reel-mounting region at the control end of a fishing rod, and (2) a sturdy, light-weight reel-carriage device that is adapted to be surely coupled at its top surface to the base of a fishing reel and is adapted to be slidably, adjustably, and lockably coupled at its lower surfaces to the longitudinal track. Among the key advantages of the fishing-reel-mounting apparatus is the ability for fishermen in the field to easily manipulate the balance of a fishing rod by allowing the adjustment of the longitudinal position of a fishing reel attached to a fishing rod.

### BACKGROUND

Fly fishing is a sport enjoyed be many persons, and is increasing in popularity. However, fly casting and presenting an artificial fly to feeding fish with a traditional fly rod-and-reel apparatus can be a very challenging art. A fly fisherman must often contend with uncooperative winds and/or relatively small targets amongst trees and brush when attempting to land an artificial fly (or flies when using multi-fly rigs) on waters harboring fish. Even expert fly fishermen can find fly casting difficult in such situations.

Nevertheless, fly casting and presentation of the fly—using a fly rod, fly reel, and the associated fly line and leader—is one of the most critical facets of fly fishing. A proper and delicate presentation of one or more artificial flies requires an extremely accurate and precise fly casting stroke. It can take many people years to become an effective fly caster, as there is a definite balance and rhythm associated with the movement of a fly rod during a casting evolution. The rhythm aspect is mostly a function of the fly fisherman's experience and comfort level with his or her equipment and the environmental conditions. Relating to the fisherman's comfort level, the balance of the fly rod is a critical factor when attempting to make an accurate and precise cast to present an artificial fly in a way to attract fish, as opposed to scaring them off.

Several factors affect the balance of a fly rod system, including the length of the fly rod, the size of the fly reel, and the weight of the fly line. However, the positioning of the fly reel along the fly rod also has a profound effect on the balance of the fly rod and the ability of the fly fisherman to make an accurate and precise fly casting stroke. Moreover, depending on many factors—such as the size and type of artificial fly being cast, the type and weight of the fly line in the fly reel, or the type of cast being executed by the fly fisherman—the proper balance of the fly rod required to make an accurate and precise fly casting stroke for a specific presentation can change from fishing hole to fishing hole, or even from cast to cast. Some fly fishermen even carry multiple fly reels in the field for swap-outs to address specific situations.

The vast majority fly reels are statically coupled to a fly rod proximal the base or handle portion thereof because of the need for a fly fisherman to simultaneously manipulate both the fly rod with one hand and the fly line emanating from the fly reel. Typical fly-reel mounting mechanisms comprise a pair of generally opposed annular or cylindrical sleeves at the base of a fly rod. The annular or cylindrical sleeves are configured to receive a portion of an anchor section of a fly reel. Typically, one of the pair of generally opposed annular or cylindrical sleeves can be moved longitudinally along the fly rod base and the other remains stationary, eventually forming a clamping force over the fly reel's anchor section/mounting base, which is received by the two annular/cylindrical sleeves. The movable annular/cylindrical sleeve is secured in position by a securing member that is threadably engaged with the fly rod base. Generally, the fly reel may be decoupled from the fly rod after use; however, the fly reel cannot be adjusted to various positions or locations longitudinally along the handle portion while in use, which in turn means that the balance of the overall fly rod cannot be adjusted by maneuvering the position of the fly reel.

One attempt to solve this problem is the “Balance Adjustable Reel Arm”, described, as of the date of filing of the present patent application, at URL http://www.rossreels.com/products/reel-arm/balance-reel-arm.cfm by Ross Reels®. The Ross device is seated into the normal fishing-rod carriage, and from that seating extends a relatively large arm into which a fishing reel can be mounted. The Ross device also has thread-based balancing wheels to move the relative position of the entire arm up or down the fishing rod. Besides being very bulky (a fishing reel must be mounted a significant lateral distance from the fishing rod using this device, which adversely affects system balance), the Ross device does not allow for a fly reel to be mounted anywhere near the rearmost portion of the rod handle.

In addition, while most fly fisherman primarily use a traditional fly rod-and-reel apparatus to ply their sport, on occasion a fly fisherman comes across a situation where he or she cannot effectively cast a fly line far enough and/or wade far enough into the waters to reach the target area where fish are feeding. In such situations, some fly fisherman carry with them into the field the ability to switch their fishing configuration from a traditional fly casting setup to a traditional spin-casting or spinning-reel setup, wherein a clear-plastic “bubble” and artificial fly rig can be cast over relatively long distances via monofilament line. Unfortunately, a typical spin-cast reel or spinning reel is not designed to be easily used from the extreme base of a fly rod because the line-release button disposed at the rear of the reel is difficult, if not impossible for some, to use if the fisherman attempts to cast using only one arm/hand on the fishing rod.

In some situations, the fly fisherman use a fishing rod that is not a true fly rod, but whose base/handle can be reconfigured to hold a fly reel at the base of the fishing rod or to hold a spin-cast or spinning reel with a substantial free handle disposed toward the base of the fishing rod. One such example is the TRAILMASTER® Pack rod by Eagle Claw®, described, as of the date of filing of the present patent application, at URL http://www.eagleclaw.com/site/products/rods-reels/trailmaster. While the TRAILMASTER, when in the spin-casting configuration, allows a fisherman to have the convenient handle for a fisherman to effectively hold and cast his or her line with one hand, the TRAILMASTER (and products like it) does not present a good, balanced fly-rod when in the fly-rod configuration.

What would be beneficial is a system or apparatus that would facilitate a fly fisherman's ability to readily adjust the balance of his or her fly rod in the field. Moreover, ideally, such a system or apparatus would also allow a fly fisherman to more easily convert his or her fly rod for effective use with a spin-cast reel or spinning reel in the field a fishing conditions call for.

### BRIEF DESCRIPTION OF THE DRAWINGS

FIG. 1 depicts one embodiment of an adjustable fishing-reel-mounting apparatus, as viewed isometrically from the bottom of the apparatus; that is, viewing the surface that interfaces with the reel-mounting region of a fishing rod.

FIG. 2 depicts one embodiment of the reel-mounting member of an adjustable fishing-reel-mounting apparatus separated from one embodiment of the track carriage of an adjustable fishing-reel-mounting apparatus.

FIG. 3 depicts one embodiment of a side view of an adjustable fishing-reel-mounting apparatus, specifically showing the side where a plurality of position-locking teeth is disposed along one of the longitudinal tracks of the reel-mounting member.

FIG. 4 depicts one embodiment of a top view of an adjustable fishing-reel-mounting apparatus.

FIG. 5 depicts an end view of one embodiment of the reel-mounting member of an adjustable fishing-reel-mounting apparatus and a corresponding end view of one embodiment of a separate the track carriage of an adjustable fishing-reel-mounting apparatus.

FIG. 6 depicts one embodiment of a fully assembled and installed adjustable fishing-reel-mounting apparatus as part of a complete fly rod-and-reel combination.

FIG. 7 depicts an alternate embodiment of the reel-mounting member of an adjustable fishing-reel-mounting apparatus, wherein the reel-mounting member is actually manufactured as an integral part of the fishing rod, at the handle area. In this alternate embodiment, an end cap on the fishing rod handle can be removed to allow for slidably attaching the track carriage to the reel-mounting member, after which the end cap is reinstalled.

### DETAILED DESCRIPTION

### Overview

The present disclosure is directed generally to an apparatus used to adjustably mount a fishing reel to the control end of a fishing rod. The fishing-reel-mounting apparatus is comprised of two main parts: (1) a rigid, light-weight longitudinal track that is adapted to be securely and coupled to the standard reel-mounting region at the control end of a fishing rod, and (2) a sturdy, light-weight reel-carriage device that is adapted to be surely coupled at its top surface to the base of a fishing reel and is adapted to be slidably, adjustably, and lockably coupled at its lower surfaces to the longitudinal track.

Among the key advantages of the fishing-reel-mounting apparatus is the ability for a fisherman in the field to easily manipulate the “feel” or balance of a fishing rod by allowing the adjustment of the longitudinal position of a fishing reel attached to a fishing rod relative to the base of the fishing rod (or control end where a user typically grips the fishing rod).

Another key advantage of the fishing-reel-mounting apparatus is that it allows a fly fisherman using a traditional fly rod to more-effectively be able to change the attached fishing reel from a fly reel to a typical spin-casting type of reel in order to facilitate other types of fishing, including fly fishing using a rig that employs one or more artificial flies at the end of a leader line coming from a clear-plastic “bubble” floating casting weight. In such a situation, the fly fisherman can adjust the position of the spin-casting type reel to be mounted more distally from the base end of the fly rod, thus making the use of a spin-casting type of reel on a fly rod easier for the fisherman.

### TERMINOLOGY

The terms and phrases as indicated in quotes (“ ”) in this section are intended to have the meaning ascribed to them in this Terminology section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification and the appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation” in various places in the specification are not necessarily all meant to refer to the same embodiment.

The terms “couple” or “coupled”, as used in this specification and the appended claims, each refer to either an indirect or a direct connection between the identified elements, components, or objects. Often the manner of the coupling will be related specifically to the manner in which the two coupled elements interact. If a reference to either the term “couple” or “coupled” is not used with a modifier or accompanying limiting textual description, such as, for example, “fixedly”, “permanently”, “removably”, or “detachably”, then a reference to “coupled” is not intended to be limited to a form of coupling that would exclude other forms of coupling.

The terms “removable”, “removably coupled”, “readily removable”, “readily detachable”, and similar terms, as used in this patent application specification (including the claims and drawings), refer to structures that can be uncoupled from an adjoining structure with relative ease (i.e., non-destructively and without a complicated or time-consuming process) and that can also be readily reattached or coupled to the previously adjoining structure.

Directional and/or relational terms such as, but not limited to, “left”, “right”, “nadir”, “apex”, “top”, “bottom”, “vertical”, “horizontal”, “back”, “front”, and “lateral” are relative to each other, are dependent on the specific orientation of an applicable element or article, are used accordingly to aid in the description of the various embodiments, and are not necessarily intended to be construed as limiting.

As applicable, the terms “about” or “generally”, as used herein unless otherwise indicated, mean a margin of +−20%. Also, as applicable, the term “substantially” as used herein unless otherwise indicated means a margin of +−10%. It is to be appreciated that not all uses of the above terms are quantifiable such that the referenced ranges can be applied.

The term “fishing rod”, as used in this patent application specification (including the claims and drawings), refer to any type of rod or pole (rigid or flexibly rigid) adapted for the sport of fishing (also called angling) for fish using at least one fishing line and some sort of bait or lure, artificial or natural, at the end of the line. In the context of this patent application, it is generally expected that a fishing rod will have a region dedicated toward the base end (or control end) for mounting some sort of fishing reel that contains fishing line.

### First Embodiment

### A Fishing-Reel-Mounting Apparatus

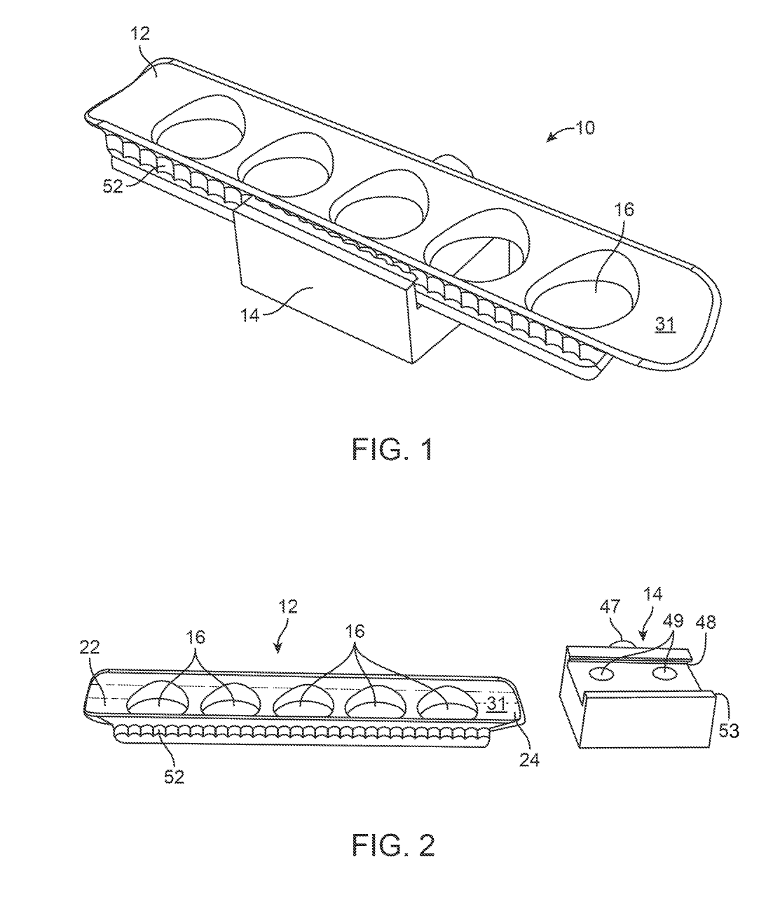

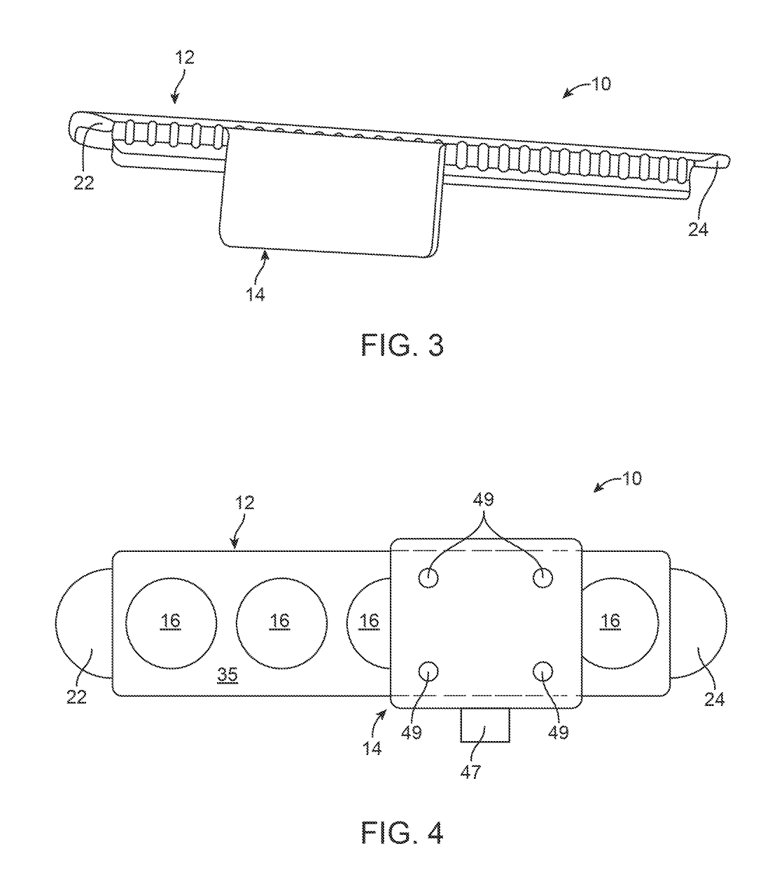

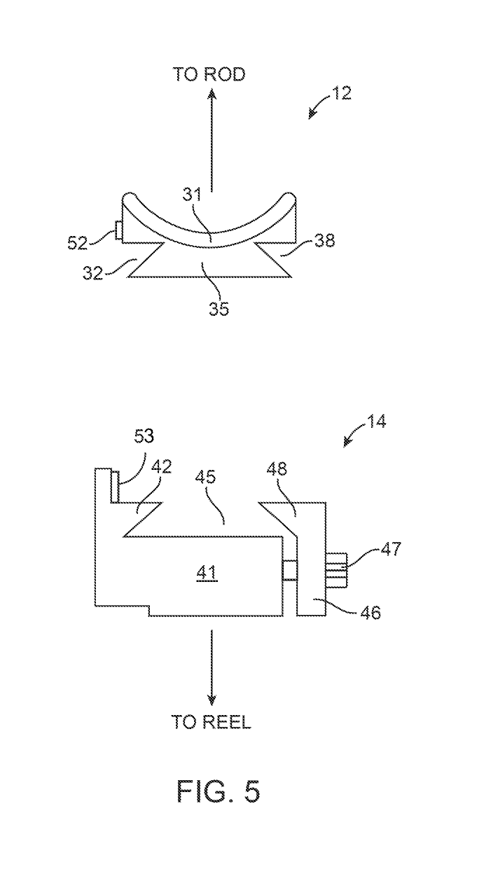

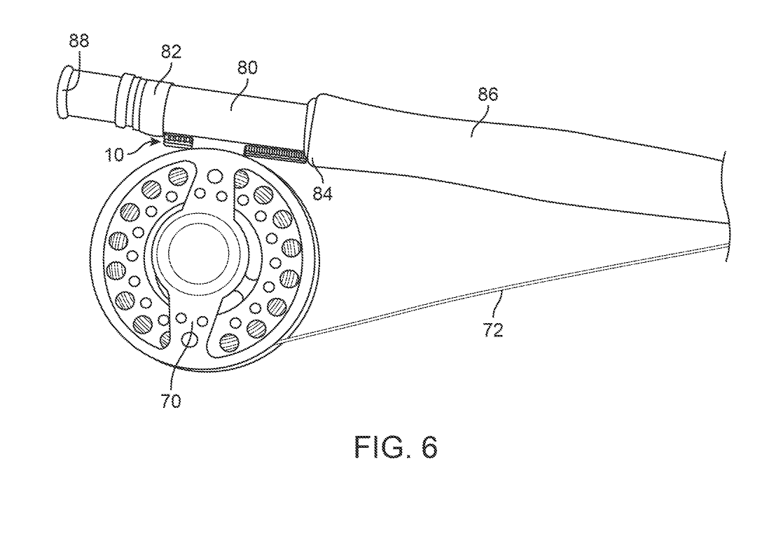

Refer to FIGS. 1-6. This embodiment is directed generally to a fishing-reel-mounting apparatus 10 that facilitates easy rebalancing of a fishing reel and rod assembly by a fisherman in the field to aid in subsequent angling activities. Rod balancing while fly fishing is advantageous to many fly fisherman because it allows for balance adjustments when switching between different fly-reel 70 sizes and corresponding fly line 72 weights, as well as balance adjustments for specific casts being performed with the same fly reel 70.

In an embodiment, the fishing-reel-mounting apparatus 10 comprises two main components: (1) a rigid, light-weight, reel-mounting member 12 that is adapted to be coupled to the standard reel-mounting region 80 at the control end of a fishing rod 80, 82, 84, 86, 88, and (2) a sturdy, light-weight, track carriage device 14 that is adapted to be surely coupled at its top surface to the base of a fishing reel 70 and is adapted to be slidably, adjustably, and lockably coupled at its lower surfaces 42, 45, 48, 52 to the longitudinal track 12.

In an embodiment, the rigid reel-mounting member 12 has a first end 22, a second end 24, a bottom surface 31, a top surface 35, a first longitudinal track 32, 52, and a second longitudinal track 38, wherein the reel-mounting member 12 is adapted to be coupled to the reel-mounting section 80, 82, 84 of a fishing-rod handle 80, 82, 84, 86, 88. In some variations, the first longitudinal track 32, 52 includes a plurality of position-locking teeth 52, though in other variations, the second longitudinal track 38 can also host the plurality of position-locking teeth 52 instead of, or even in addition to, the first longitudinal track 32, 52.

The reel-mounting member 12 can be adapted to be coupled to a wide variety of shapes and lengths of the control end of a fishing rod 80, 82, 84, 86, 88. However, most fishing rods are equipped with a reel-mounting surface that is substantially rounded or arcuate, along with at least two sleeve-type members (one of which is usually in a fixed position and the other which is slidably repositionable and securable), wherein the sleeve-type members are designed to receive and establish a secure fit with the ends of a typical fishing-reel mount. Consequently, in many embodiments of the present inventive concept, the bottom surface 31 of the reel-mounting member 12 is laterally arcuate and the first and second ends of the reel-mounting member 12 are adapted to be slidably and securably received by the sleeves 82, 84 on the fishing-rod handle 80, 82, 84, 86, 88, thus facilitating the substantial surface-to-surface coupling between the bottom surface 31 and a substantially laterally rounded reel-seating surface 80 of a fishing-rod handle 80, 82, 84, 86, 88. In most variations, the fishing rod's reel-mounting region 80, 82, 84 is equipped with a threaded member that is employed by a user to secure the position of the movable sleeve 82. Often, this threaded member is a round thumb nut that is threaded onto threads disposed on the shaft in the reel-mounting region of the fishing rod. In some other cases, this threaded member is a screw or bolt that is screwed orthogonally into the shaft of the fishing rod in order to fix the position of the movable sleeve.

In a typical embodiment, the track carriage 14 has a top surface, often with a plurality of fastener-receiving holes 49, for fixed attachment to a fishing reel's 70 bottom-disposed surfaces that include track-carriage interface surfaces. In addition, many variations include a position-locking clamp device 46, 47, 48, wherein the lateral sides of the track-interface surfaces 42, 45, 48, 53 are adapted to slidably interlock with the first and second longitudinal tracks 32, 52, 38 of the reel-mounting member 12. In still other versions of this embodiment, the surface of at least one of the lateral sides of the track-interface surfaces 42, 45, 48, 53 has a plurality of teeth adapted to be able to be substantially meshed (that is, locked in position) with the plurality of teeth 52 of the first longitudinal track 32 of the reel-mounting member 12, wherein when coupled to the reel-mounting member 12, the interlocked track carriage 14 can be slidably repositioned along the longitudinal tracks 32, 52, 38 of the reel-mounting member 12. In most variations, the position-locking clamp device 46, 47, 48 is adapted to be tightened whereby the two sets of plurality of teeth 52, 53 can substantially mesh or interlock, thereby locking the position of the track carriage 14 along the longitudinal tracks 32, 38 of the reel-mounting member 12.

In some embodiments, the means by which the position-locking clamp device 46, 47, 48 can be tightened to cause the clamping action is a screw-clamp whose clamping tension is adjustable by a threaded fastener 47. The threaded fastener 47 can vary in different embodiments, and can be a Phillips screw, a flat-head screw, a hex-socket screw, a fluted socket screw, a thumb screw, or a hex bolt. In still more variations, the threaded fastener 47 is headless.

In yet more embodiments, the surface interface between the reel-mounting member 12 longitudinal tracks 32, 38 and the track carriage 14 track-interface surfaces 42, 45, 48 is of an interlocking, substantially dovetailed shape, as viewed from either end of the fishing-reel-mounting apparatus 10.

In many embodiments and variations, the reel-mounting member 12 is substantially manufactured from aluminum alloy, non-corrosive metal alloy, steel, rigid plastic, graphite, and/or composite material. Similarly, the track carriage 14 is substantially manufactured from aluminum alloy, non-corrosive metal alloy, steel, rigid plastic, graphite, and/or composite material.

In still more variations, the reel-mounting member 12 has a plurality of holes 16 disposed between the top and bottom surfaces, whereby the plurality of holes 16 reduce the weight of the apparatus 10 while maintaining the structural integrity of the apparatus 10.

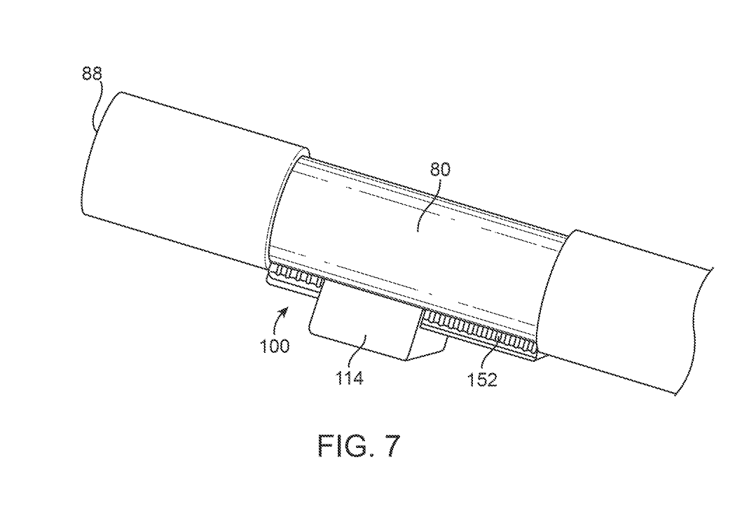

Referring to FIG. 7, in an alternate embodiment, the reel-mounting member of the fishing-reel-mounting apparatus 100 is manufactured into the handle 80, 88 of a fishing rod and the track carriage 114 is slidably engaged with the fishing-rod handle by removing the end cap 88, sliding the track carriage onto the longitudinal tracks 152 of the reel-mounting member, then replacing the end cap 88.

### Second Embodiment

### A Method of Making a Fishing-Reel-Mounting Apparatus

Refer to FIGS. 1-6. This embodiment is directed generally to a method of making a fishing-reel-mounting apparatus 10 that facilitates easy rebalancing of a fishing reel and rod assembly by a fisherman in the field to aid in subsequent angling activities. Rod balancing while fly fishing is advantageous to many fly fisherman because it allows for balance adjustments when switching between different fly-reel 70 sizes and corresponding fly line 72 weights, as well as balance adjustments for specific casts being performed with the same fly reel 70.

In an embodiment, the method comprises the steps of:
Providing a rigid reel-mounting member 12 having a first end 22, a second end 24, a bottom surface 31, a top surface 35, a first longitudinal track 32, 52, and a second longitudinal track 38, wherein the reel-mounting member 12 is adapted to be coupled to the reel-mounting section 80, 82, 84 of a fishing-rod handle 80, 82, 84, 86, 88, and wherein the first longitudinal track 32 includes a plurality of position-locking teeth 52; and
Providing a track carriage 14 having a top surface 49 for fixed attachment to a fishing reel's bottom-disposed surfaces that include track-carriage-interface surfaces, and a position-locking clamp device 46, 47, 48, wherein:
   The lateral sides of the track-interface surfaces 42, 45, 48, 53 are adapted to slidably interlock with the first and second longitudinal tracks 32, 52, 38 of the reel-mounting member 12,
   The surface of at least one of the lateral sides of the track-interface surfaces 42, 45, 48, 53 has a plurality of teeth adapted to be able to be substantially meshed with the plurality of teeth 52 of the first longitudinal track 32 of the reel-mounting member 12,
   When coupled to the reel-mounting member 12, the interlocked track carriage 14 can be slidably repositioned along the longitudinal tracks 32, 52, 38, and
   The position-locking clamp device 46, 47, 48 is adapted to be tightened whereby the two sets of plurality of teeth 52, 53 can substantially mesh, thereby locking the position of the track carriage 14 along the longitudinal tracks 32, 52, 38 of the reel-mounting member 12.

This embodiment can be further enhanced wherein the position-locking clamp device 46, 47, 48 is a screw clamp whose clamping tension is adjustable by a threaded fastener selected from the group comprising a Phillips screw, a flat-head screw, a hex-socket screw, a fluted socket screw, a thumb screw, and a hex bolt.

This embodiment can be further enhanced the surface interface between the reel-mounting member 12 longitudinal tracks 32, 52, 38 and the track carriage 14 track-interface surfaces 42, 45, 48, 53 is of an interlocking, substantially dovetailed shape, as viewed from either the first end 22 or the second end 24.

This embodiment can be further enhanced wherein the bottom surface 31 of the reel-mounting member 12 is laterally arcuate in order to facilitate the substantial surface-to-surface coupling between the bottom surface 31 and a substantially laterally rounded reel-seating surface 80 of a fishing-rod handle 80, 82, 84, 86, 88, and wherein the first end 22 and second end 24 of the reel-mounting member 12 are each adapted to slidably be received into a reel-mounting sleeve disposed on the shaft of a fishing rod 80, 82, 84, 86, 88.

This embodiment can be further enhanced wherein the reel-mounting member 12 is substantially manufactured from material selected from the group consisting of aluminum alloy, non-corrosive metal alloy, steel, rigid plastic, graphite, and composite material.

This embodiment can be further enhanced wherein the track carriage 14 is substantially manufactured from material selected from the group consisting of aluminum alloy, non-corrosive metal alloy, steel, rigid plastic, graphite, and composite material.

This embodiment can be further enhanced wherein the reel-mounting member 12 has a plurality of holes 16 disposed between the top and bottom surfaces 35, 31, whereby the plurality of holes 16 reduce the weight of the apparatus 10 while maintaining the structural integrity of the apparatus 10.

Referring to FIG. 7, in an alternate embodiment, this method of making can be modified wherein the reel-mounting member of the fishing-reel-mounting apparatus 100 is manufactured into the handle 80, 88 of a fishing rod and the track carriage 114 is slidably engaged with the fishing-rod handle by removing the end cap 88, sliding the track carriage onto the longitudinal tracks 152 of the reel-mounting member, then replacing the end cap 88.

### Third Embodiment

### A Fishing Rod-and-Reel Combination

Refer to FIGS. 1-6. This embodiment is directed generally to a fishing rod-and-reel combination 10, 70, 72, 80, 82, 84, 86, 88 that facilitates easy rebalancing of a fishing reel and rod assembly by a fisherman in the field to aid in subsequent angling activities. Rod balancing while fly fishing is advantageous to many fly fisherman because it allows for balance adjustments when switching between different fly-reel 70 sizes and corresponding fly line 72 weights, as well as balance adjustments for specific casts being performed with the same fly reel 70.

In an embodiment, the fishing rod-and-reel combination 10, 70, 72, 80, 82, 84, 86, 88 comprises:
A fishing rod 80, 82, 84, 86, 88, wherein:
   The fishing rod 80, 82, 84, 86, 88 has a handle and reel-mounting region 80, 82, 84 disposed toward the base 88 of the fishing rod, the proximal end to a user, and
   The reel-mounting region 80, 82, 84 has a laterally rounded reel-seating surface with two opposing reel-mounting sleeves, one of which is of fixed position, and the other of which has a position that can be slidably adjustable and fixed with a sleeve fastener;
A fishing-reel-mounting apparatus 10 according to the First Embodiment, described supra, wherein:
   The reel-mounting member 12 of the fishing-reel-mounting apparatus 10 is coupled to said reel-mounting region of the fishing rod 80, 82, 84, 86, 88 using the opposing reel-mounting sleeves and secured into place by tightening the sleeve fastener; and
A fishing reel, wherein:
   The fishing reel has a lower surface that is fixedly mounted to the top surface 49 of the track carriage 14 of the fishing-reel-mounting apparatus 10, and
   The track-interface surfaces 42, 45, 48, 53 of the track carriage 14 are slidably engaged with the first and second longitudinal tracks 32, 52, 38 of the reel-mounting member 12 and locked into a user-desired position by the position-locking clamp device 46, 47, 48 of the track carriage 14.

This embodiment can be further enhanced wherein the fishing rod 80, 82, 84, 86, 88 is selected from the group comprising fly rod, spinning rod, spin-cast rod, trolling rod, and bait-cast rod, trolling rod, sea rod, and telescopic rod.

This embodiment can be further enhanced wherein the fishing reel 70 is selected from the group comprising fly reel, spinning reel, spin-cast reel, bait-cast reel, and center-pin reel.

This embodiment can be further enhanced wherein the position-locking clamp device 46, 47, 48 is a screw clamp whose clamping tension is adjustable by a threaded fastener selected from the group comprising a Phillips screw, a flat-head screw, a hex-socket screw, a fluted socket screw, a thumb screw, and a hex bolt.

Referring to FIG. 7, in an alternate embodiment, this embodiment can be modified wherein the reel-mounting member of the fishing-reel-mounting apparatus 100 is manufactured into the handle 80, 88 of a fishing rod and the track carriage 114 is slidably engaged with the fishing-rod handle by removing the end cap 88, sliding the track carriage onto the longitudinal tracks 152 of the reel-mounting member, then replacing the end cap 88.

### Fourth Embodiment

### A Method of Making a Fishing Rod-and-Reel Combination

Refer to FIGS. 1-6. This embodiment is directed generally to a method of making a fishing rod-and-reel combination 10, 70, 72, 80, 82, 84, 86, 88 that facilitates easy rebalancing of a fishing reel and rod assembly by a fisherman in the field to aid in subsequent angling activities. Rod balancing while fly fishing is advantageous to many fly fisherman because it allows for balance adjustments when switching between different fly-reel 70 sizes and corresponding fly line 72 weights, as well as balance adjustments for specific casts being performed with the same fly reel 70.

In an embodiment, the method comprises the steps of:
Providing a fishing rod 80, 82, 84, 86, 88, wherein:
   The fishing rod 80, 82, 84, 86, 88 has a handle and reel-mounting region 80, 82, 84 disposed toward the base 88 of the fishing rod, the proximal end to a user, and
   The reel-mounting region 80, 82, 84 has a laterally rounded reel-seating surface with two opposing reel-mounting sleeves, one of which is of fixed position, and the other of which has a position that can be slidably adjustable and fixed with a sleeve fastener;
Providing a fishing-reel-mounting apparatus 10 according to the First Embodiment, described supra, wherein:
   The reel-mounting member 12 of the fishing-reel-mounting apparatus 10 is coupled to said reel-mounting region of the fishing rod 80, 82, 84, 86, 88 using the opposing reel-mounting sleeves and secured into place by tightening the sleeve fastener; and
Providing a fishing reel, wherein:
   The fishing reel has a lower surface that is fixedly mounted to the top surface 49 of the track carriage 14 of the fishing-reel-mounting apparatus 10, and
   The track-interface surfaces 42, 45, 48, 53 of the track carriage 14 are slidably engaged with the first and second longitudinal tracks 32, 52, 38 of the reel-mounting member 12 and locked into a user-desired position by the position-locking clamp device 46, 47, 48 of the track carriage 14.

This embodiment can be further enhanced wherein the fishing rod 80, 82, 84, 86, 88 is selected from the group comprising fly rod, spinning rod, spin-cast rod, trolling rod, and bait-cast rod, trolling rod, sea rod, and telescopic rod.

This embodiment can be further enhanced wherein the fishing reel 70 is selected from the group comprising fly reel, spinning reel, spin-cast reel, bait-cast reel, and center-pin reel.

This embodiment can be further enhanced wherein the position-locking clamp device 46, 47, 48 is a screw clamp whose clamping tension is adjustable by a threaded fastener selected from the group comprising a Phillips screw, a flat-head screw, a hex-socket screw, a fluted socket screw, a thumb screw, and a hex bolt.

This embodiment can be further enhanced the surface interface between the reel-mounting member 12 longitudinal tracks 32, 52, 38 and the track carriage 14 track-interface surfaces 42, 45, 48, 53 is of an interlocking, substantially dovetailed shape, as viewed from either the first end 22 or the second end 24.

This embodiment can be further enhanced wherein the bottom surface 31 of the reel-mounting member 12 is laterally arcuate in order to facilitate the substantial surface-to-surface coupling between the bottom surface 31 and a substantially laterally rounded reel-seating surface 80 of a fishing-rod handle 80, 82, 84, 86, 88, and wherein the first end 22 and second end 24 of the reel-mounting member 12 are each adapted to slidably be received into a reel-mounting sleeve disposed on the shaft of a fishing rod 80, 82, 84, 86, 88.

This embodiment can be further enhanced wherein the reel-mounting member 12 is substantially manufactured from material selected from the group consisting of aluminum alloy, non-corrosive metal alloy, steel, rigid plastic, graphite, and composite material.

This embodiment can be further enhanced wherein the track carriage 14 is substantially manufactured from material selected from the group consisting of aluminum alloy, non-corrosive metal alloy, steel, rigid plastic, graphite, and composite material.

This embodiment can be further enhanced wherein the reel-mounting member 12 has a plurality of holes 16 disposed between the top and bottom surfaces 35, 31, whereby the plurality of holes 16 reduce the weight of the apparatus 10 while maintaining the structural integrity of the apparatus 10.

Referring to FIG. 7, in an alternate embodiment, this method of making can be modified wherein the reel-mounting member of the fishing-reel-mounting apparatus 100 is manufactured into the handle 80, 88 of a fishing rod and the track carriage 114 is slidably engaged with the fishing-rod handle by removing the end cap 88, sliding the track carriage onto the longitudinal tracks 152 of the reel-mounting member, then replacing the end cap 88.

### Fifth Embodiment

### A Method of Using a Fishing Rod-and-Reel Combination

Refer to FIGS. 1-6. This embodiment is directed generally to a method of using a fishing rod-and-reel combination 10, 70, 72, 80, 82, 84, 86, 88 that facilitates easy rebalancing of a fishing reel and rod assembly by a fisherman in the field to aid in subsequent angling activities. Rod balancing while fly fishing is advantageous to many fly fisherman because it allows for balance adjustments when switching between different fly-reel 70 sizes and corresponding fly line 72 weights, as well as balance adjustments for specific casts being performed with the same fly reel 70.

In an embodiment, the method comprises the steps of:
Obtaining a fishing rod-and-reel combination 80, 82, 84, 86, 88 according to the Third Embodiment, described supra;
Loosening the position-locking clamp device 46, 47, 48 on the track carriage 14;
Slidably positioning the fishing reel 70 along the longitudinal tracks 32, 52, 38 of the reel-mounting member 12 of the fishing-reel-mounting apparatus 10 to a user-defined position;
Tightening the position-locking clamp device 46, 47, 48 to secure the user-defined longitudinal position of the fishing reel 70; and
Conducting fishing operations with the fishing rod-and-reel combination 80, 82, 84, 86, 88.

This embodiment can be further enhanced wherein the fishing rod 80, 82, 84, 86, 88 is selected from the group comprising fly rod, spinning rod, spin-cast rod, trolling rod, and bait-cast rod, trolling rod, sea rod, and telescopic rod.

This embodiment can be further enhanced wherein the fishing reel 70 is selected from the group comprising fly reel, spinning reel, spin-cast reel, bait-cast reel, and center-pin reel.

This embodiment can be further enhanced wherein the position-locking clamp device 46, 47, 48 is a screw clamp whose clamping tension is adjustable by a threaded fastener selected from the group comprising a Phillips screw, a flat-head screw, a hex-socket screw, a fluted socket screw, a thumb screw, and a hex bolt.

This embodiment can be further enhanced the surface interface between the reel-mounting member 12 longitudinal tracks 32, 52, 38 and the track carriage 14 track-interface surfaces 42, 45, 48, 53 is of an interlocking, substantially dovetailed shape, as viewed from either the first end 22 or the second end 24.

This embodiment can be further enhanced wherein the bottom surface 31 of the reel-mounting member 12 is laterally arcuate in order to facilitate the substantial surface-to-surface coupling between the bottom surface 31 and a substantially laterally rounded reel-seating surface 80 of a fishing-rod handle 80, 82, 84, 86, 88, and wherein the first end 22 and second end 24 of the reel-mounting member 12 are each adapted to slidably be received into a reel-mounting sleeve disposed on the shaft of a fishing rod 80, 82, 84, 86, 88.

This embodiment can be further enhanced wherein the reel-mounting member 12 is substantially manufactured from material selected from the group consisting of aluminum alloy, non-corrosive metal alloy, steel, rigid plastic, graphite, and composite material.

This embodiment can be further enhanced wherein the track carriage 14 is substantially manufactured from material selected from the group consisting of aluminum alloy, non-corrosive metal alloy, steel, rigid plastic, graphite, and composite material.

This embodiment can be further enhanced wherein the reel-mounting member 12 has a plurality of holes 16 disposed between the top and bottom surfaces 35, 31, whereby the plurality of holes 16 reduce the weight of the apparatus 10 while maintaining the structural integrity of the apparatus 10.

Referring to FIG. 7, in an alternate embodiment, this method of using can be modified wherein the reel-mounting member of the fishing-reel-mounting apparatus 100 is manufactured into the handle 80, 88 of a fishing rod and the track carriage 114 is slidably engaged with the fishing-rod handle by removing the end cap 88, sliding the track carriage onto the longitudinal tracks 152 of the reel-mounting member, then replacing the end cap 88.

### Alternative Embodiments and Other Variations

The various embodiments and variations thereof described herein and/or illustrated in the accompanying Figures are merely exemplary and are not meant to limit the scope of the inventive disclosure. It should be appreciated that numerous variations of the invention have been contemplated as would be obvious to one of ordinary skill in the art with the benefit of this disclosure.

Hence, those ordinarily skilled in the art will have no difficulty devising a myriad of obvious variations and improvements to the invention, all of which are intended to be encompassed within the scope of the claims which follow.

1. A fishing-reel-mounting apparatus, comprising:
a rigid reel-mounting member having a first end, a second end, a bottom surface, a top surface, a first longitudinal track, and a second longitudinal track,
wherein said reel-mounting member is adapted to be coupled to the reel-mounting section of a fishing-rod handle, and
wherein said first longitudinal track includes a plurality of position-locking teeth; and
a track carriage having a top surface for fixed attachment to a fishing reel's bottom-disposed surfaces that include track-carriage-interface surfaces, and a position-locking clamp device,
wherein the lateral sides of said track-interface surfaces are adapted to slidably interlock with said first and second longitudinal tracks of said reel-mounting member,
wherein the surface of at least one of said lateral sides of said track-interface surfaces has a plurality of teeth adapted to be able to be substantially meshed with said plurality of teeth of said first longitudinal track of said reel-mounting member,
wherein when coupled to said reel-mounting member, said interlocked track carriage can be slidably repositioned along said longitudinal tracks, and
wherein said position-locking clamp device is adapted to be tightened whereby said two sets of plurality of teeth can substantially mesh, thereby locking the position of said track carriage along said longitudinal tracks of said reel-mounting member.

2. The fishing-reel-mounting apparatus of claim 1, wherein said position-locking clamp device is a screw clamp whose clamping tension is adjustable by a threaded fastener selected from the group comprising a Phillips screw, a flat-head screw, a hex-socket screw, a fluted socket screw, a thumb screw, and a hex bolt.

3. The fishing-reel-mounting apparatus of claim 2, wherein said threaded fastener is headless.

4. The fishing-reel-mounting apparatus of claim 1, wherein said surface interface between said reel-mounting member longitudinal tracks and said track carriage track-interface surfaces is of an interlocking, substantially dovetailed shape, as viewed from either said first end or said second end.

5. The fishing-reel-mounting apparatus of claim 1, wherein:
said bottom surface of said reel-mounting member is laterally arcuate in order to facilitate the substantial surface-to-surface coupling between said bottom surface and a substantially laterally rounded reel-seating surface of a fishing-rod handle, and
said first end and second end of said reel-mounting member are each adapted to slidably be received into a reel-mounting sleeve disposed on the shaft of a fishing rod.

6. The fishing-reel-mounting apparatus of claim 1, wherein said reel-mounting member is substantially manufactured from material selected from the group consisting of aluminum alloy, non-corrosive metal alloy, steel, rigid plastic, graphite, and composite material.

7. The fishing-reel-mounting apparatus of claim 6, wherein said reel-mounting member has a plurality of holes disposed between said top and bottom surfaces, whereby said plurality of holes reduce the weight of said apparatus while maintaining the structural integrity of said apparatus.

8. A fishing rod-and-reel combination, comprising:
a fishing rod,
wherein said fishing rod has a handle and reel-mounting region disposed toward the base of said fishing rod, the proximal end to a user, and
wherein said reel-mounting region has a laterally rounded reel-seating surface with two opposing reel-mounting sleeves, one of which is of fixed position, and the other of which has a position that can be slidably adjustable and fixed with a sleeve fastener;
a fishing-reel-mounting apparatus according to claim 1,
wherein the reel-mounting member of said fishing-reel-mounting apparatus is coupled to said reel-mounting region of said fishing rod using said opposing reel-mounting sleeves and secured into place by tightening said sleeve fastener; and
a fishing reel,
wherein said fishing reel has a lower surface that is fixedly mounted to the top surface of the track carriage of said fishing-reel-mounting apparatus, and
wherein said track-interface surfaces of said track carriage are slidably engaged with the first and second longitudinal tracks of said reel-mounting member and locked into a user-desired position by the position-locking clamp device of said track carriage.

9. The fishing rod-and-reel combination of claim 8, wherein said fishing rod is selected from the group comprising fly rod, spinning rod, spin-cast rod, trolling rod, and bait-cast rod, trolling rod, sea rod, and telescopic rod.

10. The fishing rod-and-reel combination of claim 8, wherein said fishing reel is selected from the group comprising fly reel, spinning reel, spin-cast reel, bait-cast reel, and center-pin reel.

11. The fishing rod-and-reel combination of claim 8, wherein said position-locking clamp device is a screw clamp whose clamping tension is adjustable by a threaded fastener selected from the group comprising a Phillips screw, a flat-head screw, a hex-socket screw, a fluted socket screw, a thumb screw, and a hex bolt.

12.-26. (canceled)

27. A fishing rod-and-reel combination equipped with an adjustable fishing-reel-mounting apparatus, comprising:
a fishing rod,
wherein said fishing rod has a handle and reel-mounting section disposed toward the base of said fishing rod, the proximal end to a user,
wherein said reel-mounting section has a rigid reel-mounting member having a first end, a second end, a top surface, a first longitudinal track, and a second longitudinal track,
wherein said reel-mounting member is manufactured into the reel-mounting section of said fishing-rod handle,
wherein said first longitudinal track includes a plurality of position-locking teeth, and
wherein said first end of said reel-mounting member is adapted to slidably engage with an end cap that is removably attached to the end of said fishing rod;
a track carriage having a top surface for fixed attachment to a fishing reel's bottom-disposed surfaces that include track-carriage-interface surfaces, and a position-locking clamp device,
wherein the lateral sides of said track-interface surfaces are adapted to slidably interlock with said first and second longitudinal tracks of said reel-mounting member by first removing said end cap, slidably installing said track-carriage, then reinstalling said end cap,
wherein the surface of at least one of said lateral sides of said track-interface surfaces has a plurality of teeth adapted to be able to be substantially meshed with said plurality of teeth of said first longitudinal track of said reel-mounting member,
wherein when coupled to said reel-mounting member, said interlocked track carriage can be slidably repositioned along said longitudinal tracks, and
wherein said position-locking clamp device is adapted to be tightened whereby said two sets of plurality of teeth can substantially mesh, thereby locking the position of said track carriage along said longitudinal tracks of said reel-mounting member; and
a fishing reel,
wherein said fishing reel has a lower surface that is fixedly mounted to the top surface of the track carriage of said fishing-reel-mounting apparatus, and
wherein said track-interface surfaces of said track carriage are slidably engaged with the first and second longitudinal tracks of said reel-mounting member and locked into a user-desired position by the position-locking clamp device of said track carriage.

28. The fishing rod-and-reel combination of claim 27, wherein said fishing rod is selected from the group comprising fly rod, spinning rod, spin-cast rod, trolling rod, and bait-cast rod, trolling rod, sea rod, and telescopic rod.

29. The fishing rod-and-reel combination of claim 27, wherein said fishing reel is selected from the group comprising fly reel, spinning reel, spin-cast reel, bait-cast reel, and center-pin reel.

30. The fishing rod-and-reel combination of claim 27, wherein said position-locking clamp device is a screw clamp whose clamping tension is adjustable by a threaded fastener selected from the group comprising a Phillips screw, a flat-head screw, a hex-socket screw, a fluted socket screw, a thumb screw, and a hex bolt.

31. The fishing rod-and-reel combination of claim 30, wherein said threaded fastener is headless.

32. The fishing rod-and-reel combination of claim 27, wherein said surface interface between said reel-mounting member longitudinal tracks and said track carriage track-interface surfaces is of an interlocking, substantially dovetailed shape, as viewed from either said first end or said second end.

33. The fishing rod-and-reel combination of claim 27, wherein said reel-mounting member is substantially manufactured from material selected from the group consisting of aluminum alloy, non-corrosive metal alloy, steel, rigid plastic, graphite, and composite material.

34. The fishing rod-and-reel combination of claim 33, wherein said reel-mounting member has a plurality of holes disposed between said top and bottom surfaces, whereby said plurality of holes reduce the weight of said apparatus while maintaining the structural integrity of said reel-mounting member.

35.-45. (canceled)
